(19) United States
(12) Patent Application Publication
(10) Pub. No.: US 2017/0291765 A1
(43) Pub. Date: Oct. 12, 2017

(54) REFUSE COLLECTION TRUCK HAVING A LOW PROFILE LOADER

(71) Applicant: Anthony Stephen Kouri, Breckenridge, TX (US)

(72) Inventor: Anthony Stephen Kouri, Breckenridge, TX (US)

(21) Appl. No.: 15/096,714

(22) Filed: Apr. 12, 2016

(51) Int. Cl. B65F 3/02

(52) U.S. Cl. CPC B65F 3/0203; B65F 2003/023; B65F 2003/0226; B65F 2003/0266; B65F 2003/0276

(57) ABSTRACT

A side loading refuse collection truck has a collection bin storing refuse placed in the refuse collection truck. A tailgate is coupled to the collection bin. A collection hopper is coupled to the collection bin, wherein the collection hopper is recessed within a body of the refuse collection truck. A side loader coupled to the collection hopper, wherein a distal end of the side loader when the collection hopper is in a stowed positon lies within a body outline of a perimeter of a body of the refuse collection truck.

### TECHNICAL FIELD

The present application in general relates to refuse collection, and more specifically, to a refuse collection truck having a low profile loader mounted within to allow the refuse collection truck to travel in narrow roadways and alleys without having to manipulate a position of lifting arms of the low profile loader.

### BACKGROUND

Refuse collection trucks are vehicles that may be designed to collect solid waste and recyclable materials. The refuse collection trucks may haul the collected waste or recyclable materials to a solid waste treatment facility such as a landfill or to a recycling center, respectively. In the past, most refuse collection trucks were non-automated and required multiple operators. One operator would drive the refuse collection truck, while one or more other operators would lift the refuse containers and empty the contents into a loading hopper located at the rear of the refuse collection truck. The operators loading the refuse would then activate a compression device to compact and push the refuse into a collection bin area located in the refuse collection trucks. This process is very time and labor intensive.

In recent years, refuse and recycle collection has become more automated. Most large municipalities have moved to standardized refuse containers that have wheels and that may be designed to have their contents automatically emptied into automated refuge collection truck after either being positioned by an operator in front of a loader, or a lifting device reaching out and grabbing the refuse container. In general, automated front loading refuge collection trucks may be used for larger commercial applications, while automated side loading refuge collection trucks may be used more for residential use.

For automated side loading procedures, the loader is typically mounted on the side of the refuse collection truck which faces the curb of the street that the refuse collection truck is traveling upon. The automated loader has a grabbing device that reaches out and grabs the refuse container, raises and empties the container into a hopper where the emptied contents are compacted and pushed into the collect bin at the rear of the refuse collection truck. In general, automated side loaders only need one operator, where the traditional rear load refuse collection trucks may require two or three operators. Automated side loaders have the additional advantage of reducing on the job injuries due to repetitive heavy lifting, and reduce the operator's exposure to the elements. The cost savings and improved working conditions have made automated side loaders a popular choice in the waste and recycling collection industry.

FIGS. 1A-1D are top-down perspective views of an existing standard automated side loader (ASL) 3 for a refuse collection truck 1 operating in a wide alley (W), where the width of the alley allows the ASL 3 to function without damage to the ASL 3. In FIG. 1A the refuse collection truck 1 enters a wide alley (W) with the grips 5 of the ASL 3 retracted to the vehicle body outline in a spread position. In FIG. 1B the grips 5 are cupped and begin to move forward toward a collection container 7. In FIG. 1C the ASL 3 extends from the truck I and the gripper arms 5 engage the collection container 7. In FIG. 1D the ASL 3 retracts back toward the truck 1 and positions the collection container 7 in a dump position.

However, in certain municipalities narrow streets or alleyways may require that the refuse collection truck have a profile where no part of the operating equipment extends beyond the body outline of the wheelbase. Existing automated side loader arms typically extend past the width of the refuse collection truck or require that the gripping arms be spread open against the side of the refuse collection body/hopper for the refuse collection truck to proceed to the next collection point. Also, the wide body/hopper on existing Automated Side Loaders along with the corresponding spread grip aims are intrusive in narrow alleys in that closing the grip arms can damage property. When existing Automated Side Loaders grip the container, they do not afford the ability to retract the loader arm grippers and cart away from obstacles before dumping the contents into the hopper.

FIG. 2 is a top-down perspective view of an existing prior art standard automated side loader (ASL) 3 for a refuse collection truck 1 in a narrow alley (N) that illustrates the operational problems associated with the existing prior art standard automated side loader 3 in a narrow alley. As can be seen in FIG. 2 there is not enough clearance for the grippers 5 of the ASL 3 to extend and grasp the collection container 7 without damaging the grips 5, ASL 3, or the obstacles and containers 7 that are present in the narrow alley (N).

Therefore, it would be desirable to provide a system and method that overcomes the above. The system and method would provide an automated side loading device with a slim profile that does not require the raising or spreading of the lift arms between collection stops in order to keep the arms from extending beyond the width of the vehicle. With the combination of recessing the hopper and installing a more compact loader arm, the gripper arms do not have to be open to stay within the legal confines of a moving motor vehicle. As with all Automated Side Loaders, containers must be reached before gripping. The operator of this truck can retract the container away from any obstacles to within the confines of the body before dumping the contents.

### SUMMARY

In accordance with one embodiment, a refuse collection truck is disclosed. The refuse collection truck has a collection bin storing refuse placed in the refuse collection truck. A tailgate is coupled to the collection bin. A collection hopper is coupled to the collection bin, wherein the collection hopper is recessed within a body of the refuse collection truck. A side loader coupled to the collection hopper, wherein a distal end of the side loader when the collection hopper is in a stowed positon lies within a body outline of a perimeter of a body of the refuse collection truck.

In accordance with one embodiment, a refuse collection truck is disclosed. The refuse collection truck has a collection bin storing refuse placed in the refuse collection truck. A tailgate is coupled to the collection bin. A collection hopper is coupled to the collection bin, wherein the collection hopper is recessed within a body of the refuse collection truck. A side loader is coupled to the collection hopper, wherein the side loader comprises: a boom arm that extends from and retracts into the body of the refuse collection truck; a pivoting telescoping arm with an upper housing and a lower arm that telescopes out from the upper housing, where a pivoting linkage connects to the upper housing to the boom arm; and a grabber formed with a pivoting right arm and a pivoting left arm joined to an extension arm, the extension arm fixedly attached to the lower arm; wherein when the side loader is stowed, the right arm and left arm of the grabber are recessed in the body of the truck in a half cupped position while remaining inside a wheel base profile of the refuse collection truck.

In accordance with one embodiment, a low profile automated side loader for a refuse collection truck is disclosed. The side loader has a boom arm that extends from and retracts into the body of a collection truck. Joined to the boom arm is a pivoting telescoping arm with an upper housing and a lower arm that telescopes out from the upper housing. The upper housing has a pivoting linkage to connect to the boom arm. A grabber or claw portion of the front loader is formed with a pivoting right arm and a left arm joined to an extension arm. The extension arm is fixedly joined to the lower arm with a joining plate. The extension arm serves to offset the grabber so as to align a collection container to be emptied with a collection hopper of the truck. A set of actuators used in the front loader may be pneumonic, hydraulic, or electrical.

### BRIEF DESCRIPTION OF THE DRAWINGS

The present application is further detailed with respect to the following drawings. These figures are not intended to limit the scope of the present application but rather illustrate certain attributes thereof.

FIGS. 1A-1D are top-down perspective views of an existing prior art standard automated side loader for a refuse collection truck operating in a wide alley;

FIG. 2 is a top-down perspective view of an existing prior art standard automated side loader for a refuse collection truck in a narrow alley that illustrates the operational problems associated with the existing prior art standard automated side loader in a narrow alley;

FIG. 3 is a perspective view of an automated side loader mounted to a refuse collection truck according to one aspect of the present application;

FIGS. 4A-4C are side, front, and top plan views, respectively, of the automated side loader of FIG. 3 according to one aspect of the present application; and

FIGS. 5A-5C are a series of perspective views showing the operation of the automated side loader of FIG. 3 in different stages of deployment in a narrow alley according to one aspect of the present application.

### DESCRIPTION OF THE APPLICATION

The description set forth below in connection with the appended drawings is intended as a description of presently preferred embodiments of the disclosure and is not intended to represent the only forms in which the present disclosure may be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that are also intended to be encompassed within the spirit and scope of this disclosure.

Embodiments of the exemplary device provide a low profile automated side loader that remains within a width of the refuse collection truck without having to fold up and lift the arms of the lift device between collection points. In specific inventive embodiments, the arms of the grabbing mechanism of the automated side loader are recessed within the body of the refuse collection truck. This way, the arms never need to be retracted while fully open and stored like in conventional refuse collection trucks, and may be stowed in a half cupped position while remaining inside the body outline of the wheelbase of the refuse collection truck. The arms may extend outwards to pick up a refuse or recycling container, but when drawn back to the refuse collection truck, the aims do not need to be raised and lifted up against the side of the truck. The design gives the refuse collection truck a thinner profile to go through narrow alleyways and/or roadways.

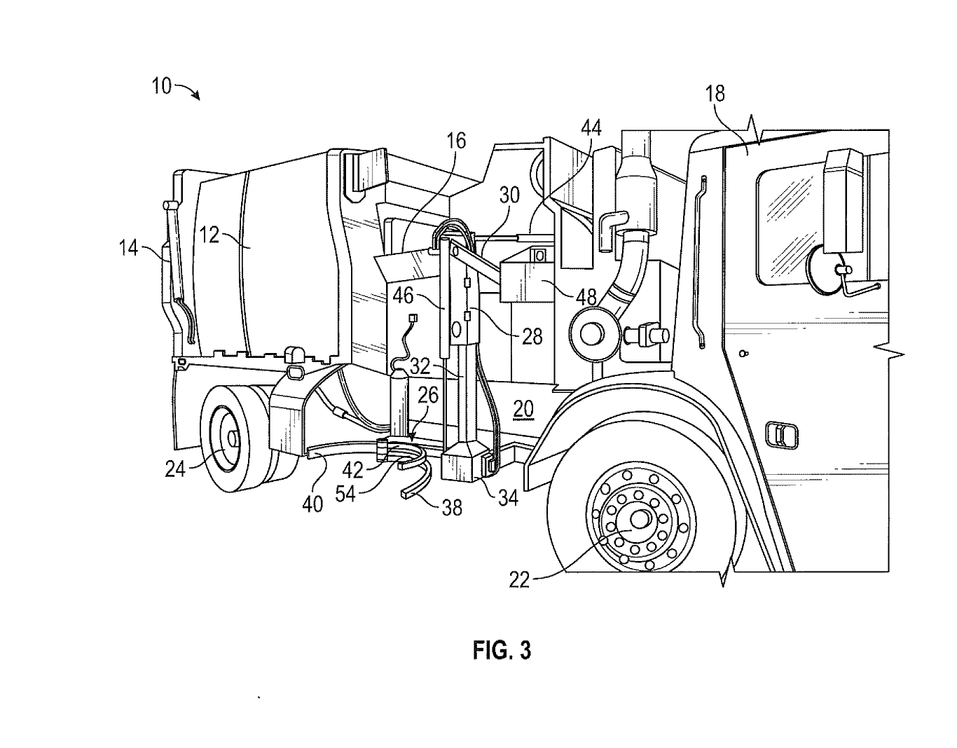

Referring to FIG. 3, a refuse collection truck 10 (hereinafter truck 10) is shown. The truck 10 may have a collection bin 12. The collection bin 12 may be used to store refuse which has been placed within and compacted by the truck 10. The truck 10 may be equipped with a tailgate 14. The tailgate 14 may be raised and opened for emptying collected contents. In accordance with one embodiment, the tailgate 14 may be located in a rear area of the truck 10. A collection hopper 16 may receive the contents collected from refuse containers, which then may be compacted prior to being transferred to the collection bin 12. In the present embodiment, the collection hopper 16 may be recessed within the body of the truck 10. More specifically, the collection hopper 16 may be recessed within the body of the truck 10 so as to be behind a body outline of the axel track of the truck 10. In other words, the collection hopper 16 may be positioned behind the wheels of the truck 10.

The collection bin 12 and hopper 16 may be mounted on a chassis frame 20 that may support the engine, drive train, fuel tank, pneumonic or hydraulic pumps, and a vehicle cab 18 which the driver may sits in and controls the operation of the truck 10 and the automated side loader 26 (hereinafter side loader 26). The chassis may be suspended by a front axle 22 and a rear axle 24. The side loader 26 may be secured to the collection hopper 16 with the pivot mechanism enclosure bracket 48. The side loader 26 may be mounted on the collection hopper 16 recessed within the body of the truck 10 and between the front axle 22 and rear axle 24, where as shown in FIG. 3, when the side loader 26 is stowed, the right arm 38 and left arm 40 (as defined when facing the truck 10) may be stowed in a half cupped position and still lie within the body outline of the wheel base of the truck 10. The wheelbase may be defined as the distance between the centers of the front and rear wheels. Thus, when the side loader 26 is stowed, the right arm 38 and left arm 40 may be stowed in a half cupped position and still lie behind a line extending from a center of the front wheel to a center of the rear wheel on the side of the truck where the side loader 26 is positioned. In the present embodiment, since the truck 10 has dual front and rear wheels, the right arm 38 and left arm 40 may be stowed in a half cupped position and still lie behind a line extending from a center of the outermost front wheel to a center of the outermost rear wheel on the side of the truck where the side loader 26 is positioned.

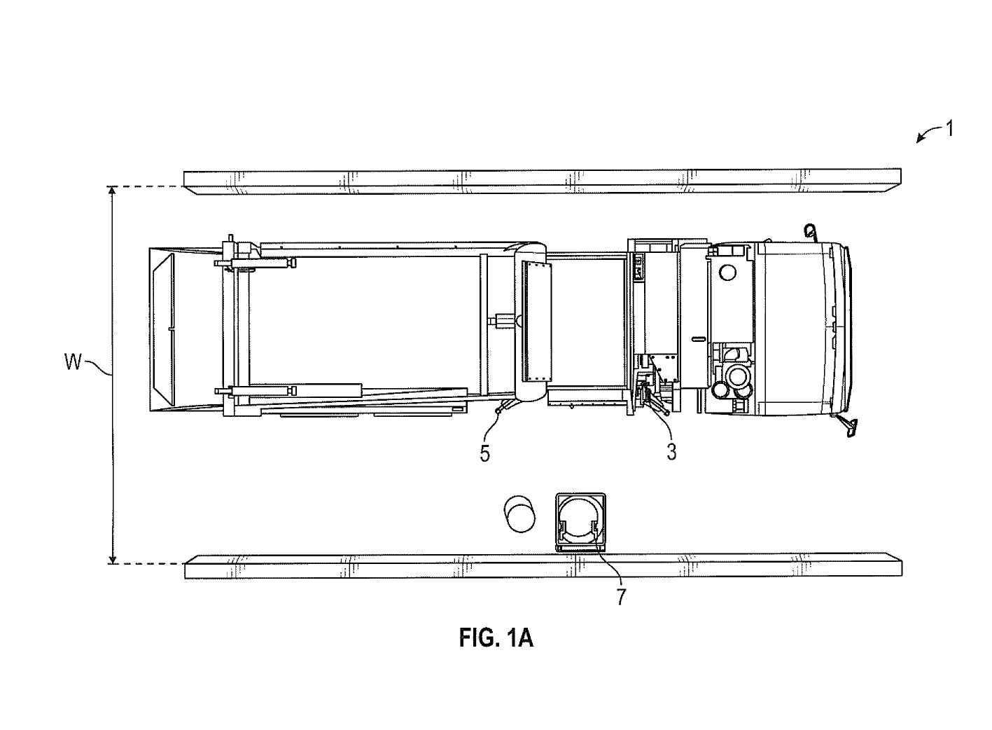

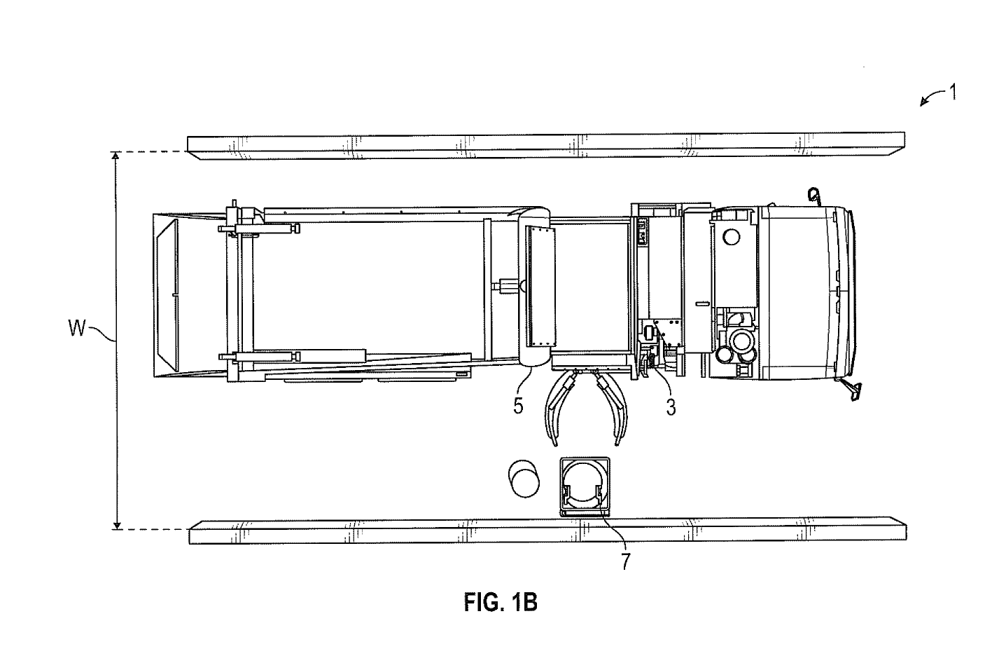

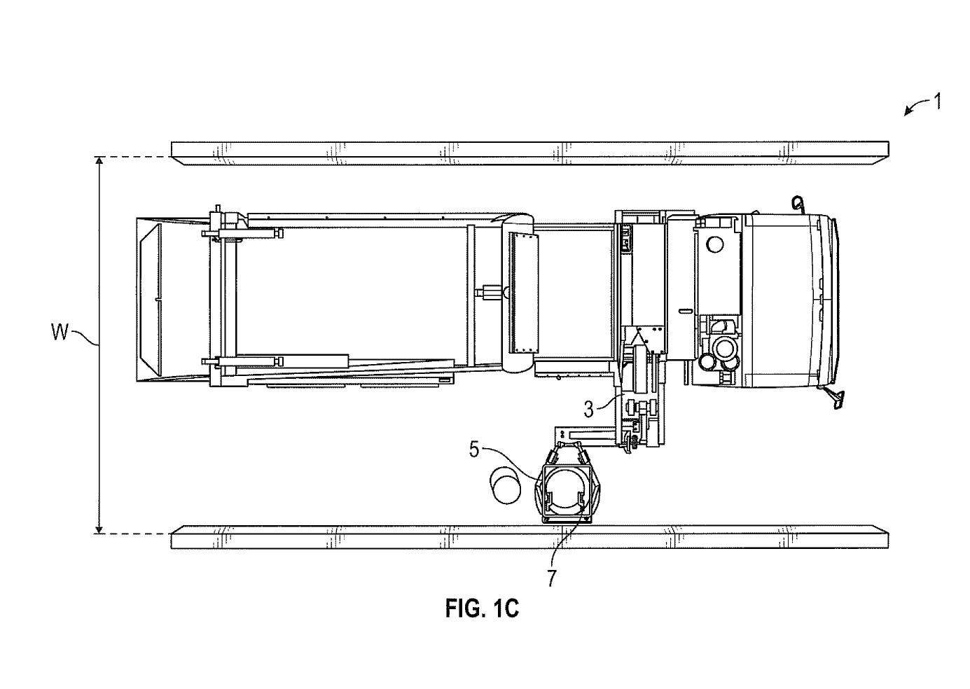

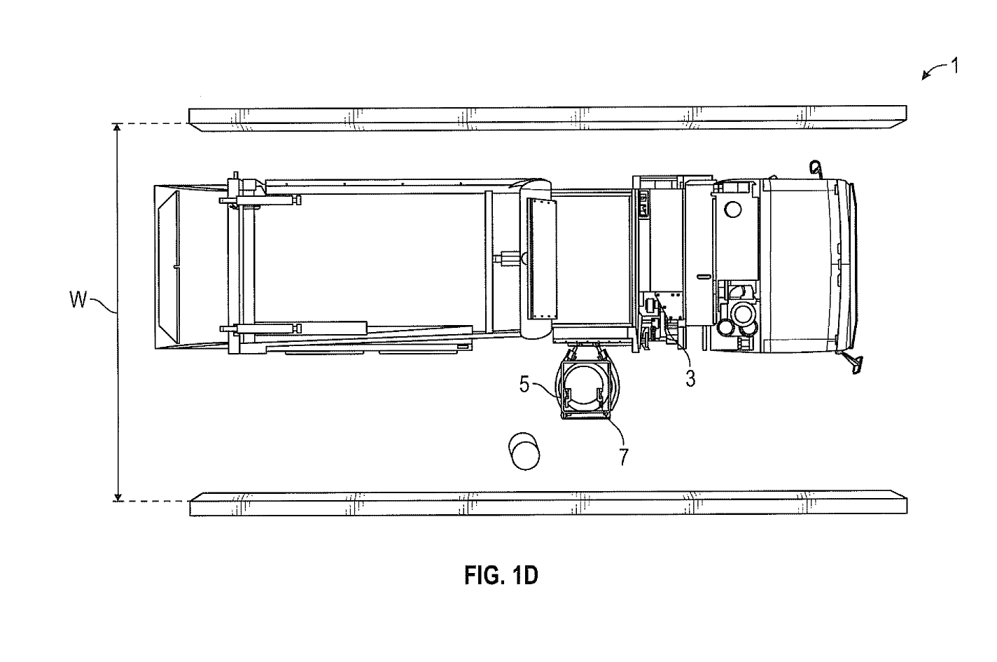

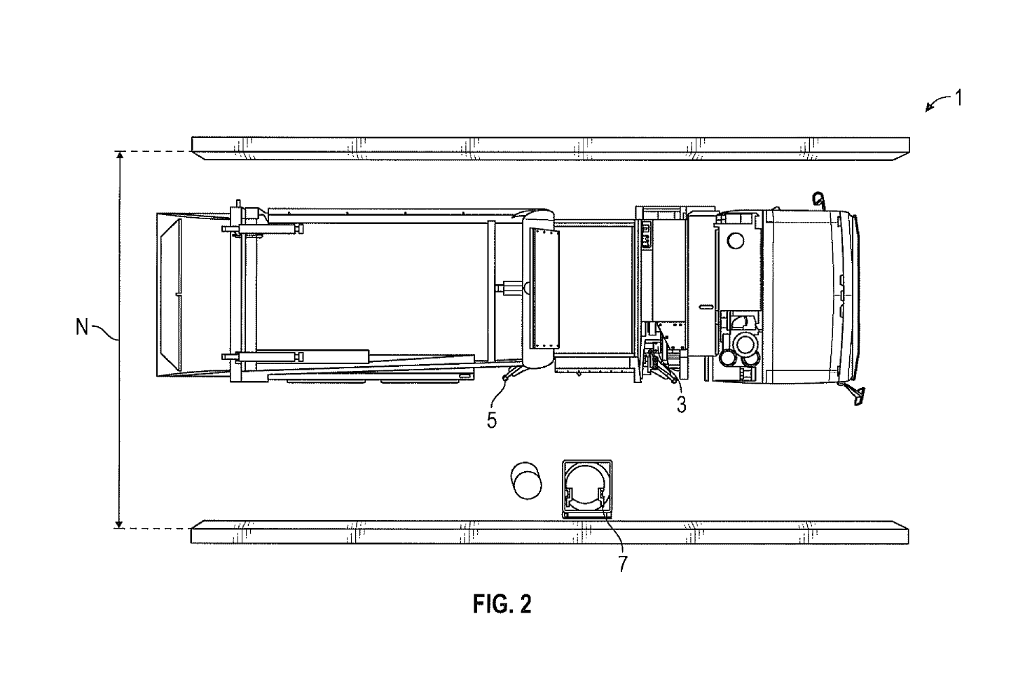

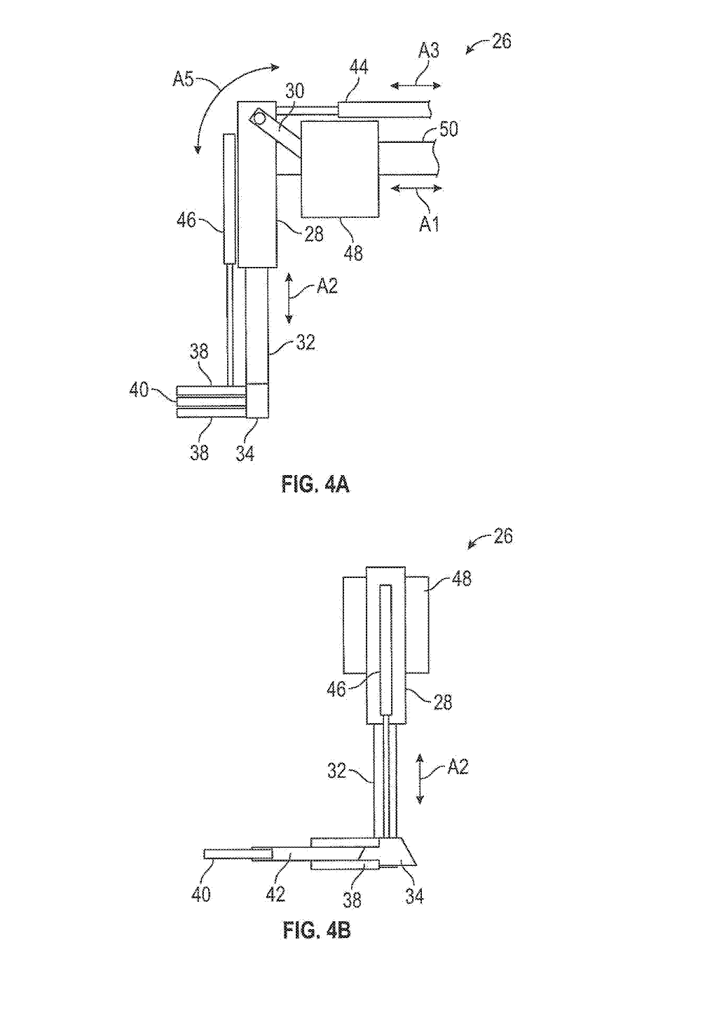

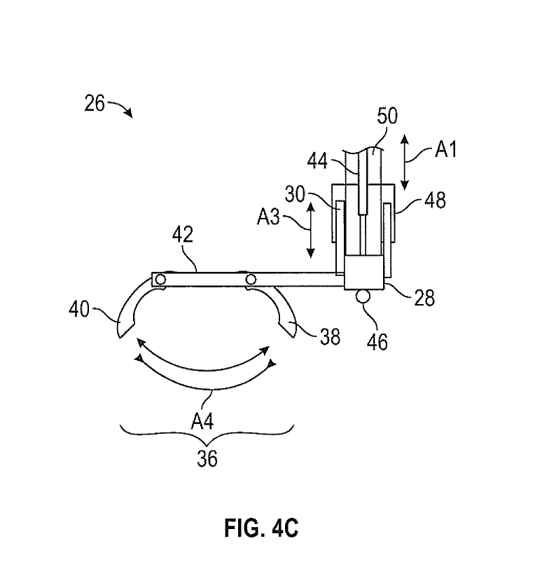

Referring to FIGS. 4A-4C the operation and construction of the side loader 26 may be disclosed. The side loader 26 may have a boom arm 50. The boom arm 50 may extend from and retract into the body of the truck 10 as indicated by bidirectional arrow A1. Joined to the boom arm 50 may be a pivoting telescoping arm with an upper housing 28 and a lower arm 32 that telescopes out from the upper housing 28. An actuator 46 may control the telescoping action of the lower arm 46 as shown by arrow A2. The upper housing 28 may have a pivoting linkage 30 to connect to the boom arm 50. An actuator 44 may control the pivoting action of the upper housing 28 as shown by bidirectional arrows A3 and A5, respectively. The grabber or claw portion 36 of the front loader 26 may be formed with pivoting right arm 38 and left awl 40 joined to an extension arm 42. The movement of the right arm 38 and left arm 40 (shown by bidirectional arrows A4) may be controlled by one or more actuators 54 positioned in the extension arm 42 that are visible in FIG. 1. The extension arm 42 may be fixedly joined to the lower arm 32 with joining plate 34. The extension arm 42 may serve to offset the grabber 36 so as to align a collection container 52 to be emptied with the collection hopper 14. The actuators 44, 46 and 54 used in the front loader 26 may be pneumonic, hydraulic, or electrical.

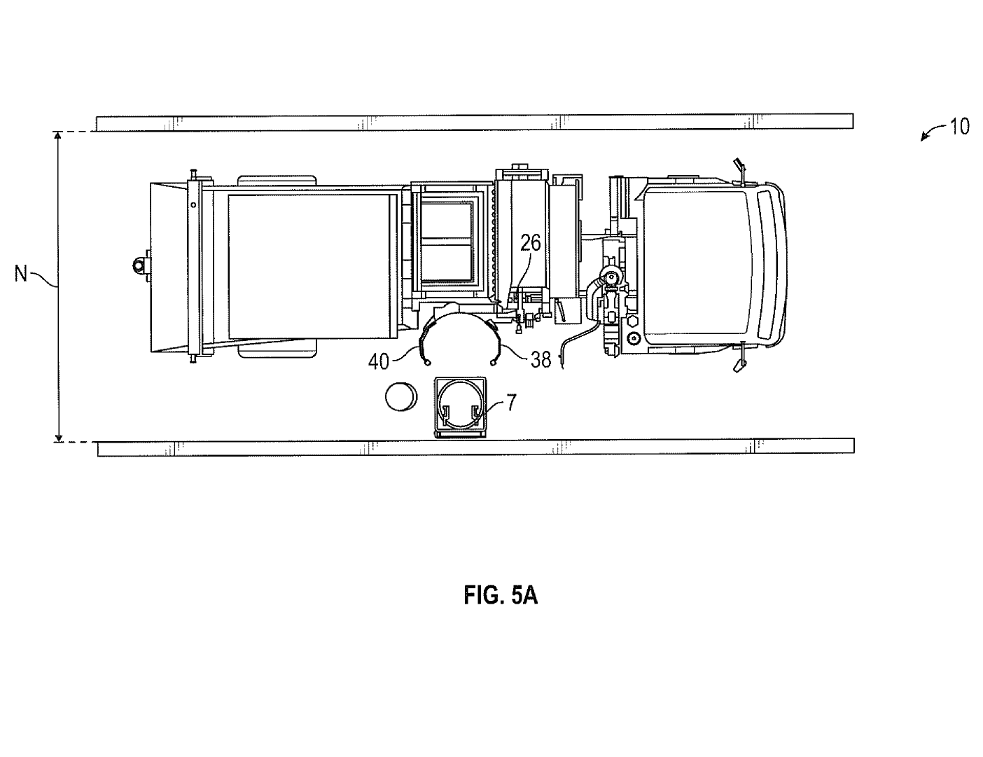

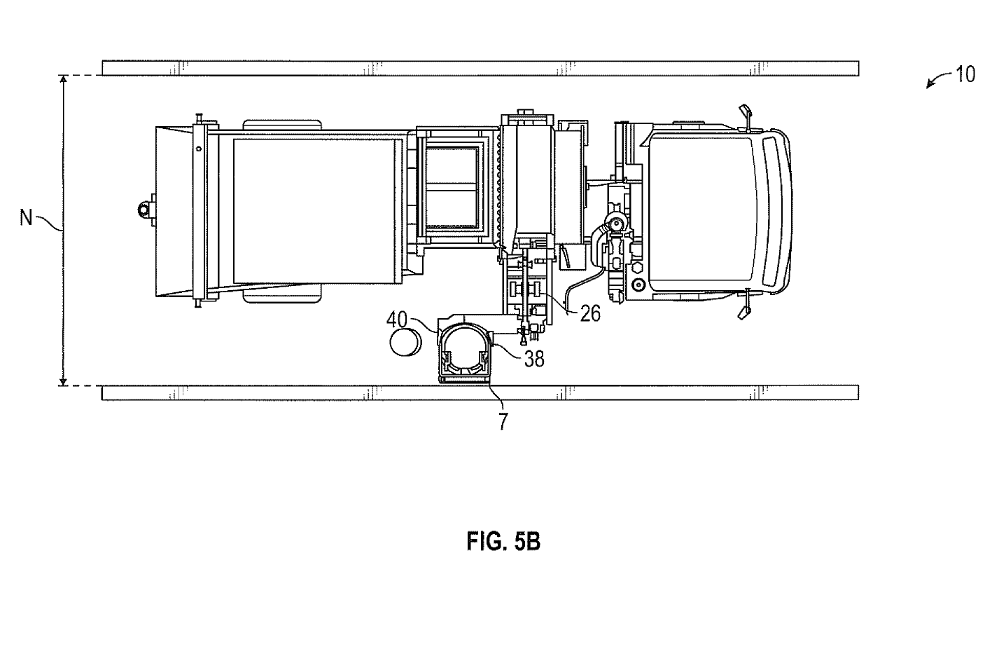

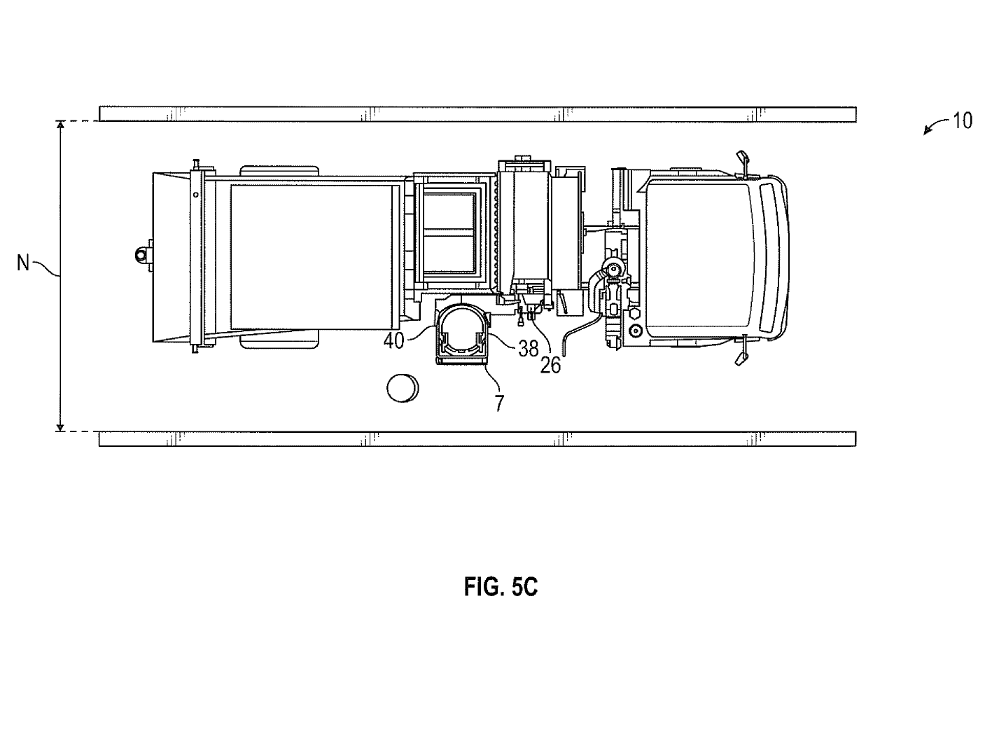

FIGS. 5A-5C are a series of perspective views showing the operation of the automated side loader 36 of FIG. 3 in different stages of deployment in a narrow alley (N). FIG. 5A illustrates an embodiment of the inventive ASL 36 of the truck 10 stowed in a half cupped position and still lie within the wheel base of the truck 10, and still be able to avoid hitting collection containers 7 or other obstacles in the narrow alley (N). FIG. 5B illustrates the ASL 36 extending from the truck 10 and gripping the collection container 7. In a specific embodiment a set of sensors automatically stop the extension of the boom when contact between a backstop of the grabber and the container is realized. In FIG. 5C the ASL 36 retracts back toward the truck 10 and positions the collection container 7 in a dump position to the collection hopper 16 (see FIG. 3). As is clearly seen in FIGS. 5A-5C, the inventive ASL 36 is able to operate in a narrow alley (N)

Embodiments of the exemplary device provide a low profile automated side loader that remains within a width of the refuse collection truck axel track without having to fold up and lift the arms of the lift device between collection points. The arms of the grabbing mechanism of the automated side loader are recessed in the body of the refuse collection truck. This way, the arms never need to be retracted upward and stored like in conventional refuse collection trucks, and may be stowed in a half cupped position while remaining inside the axel track of the refuse collection truck. The arms may extend outwards to pick up a refuse or recycling container, but when drawn back to the refuse collection truck, the arms do not need to be raised and lifted up against the side of the truck.

The foregoing description is illustrative of particular embodiments of the application, but is not meant to be a limitation upon the practice thereof. The following claims, including all equivalents thereof, are intended to define the scope of the invention.

1. A refuse collection truck, comprising:
a collection bin storing refuse placed in the refuse collection truck;
a tailgate coupled to the collection bin;
a collection hopper coupled to the collection bin, wherein the collection hopper is recessed within a body of the refuse collection truck; and
a side loader coupled to the collection hopper, wherein a distal end of the side loader when the collection hopper is in a stowed positon lies within a body outline of a perimeter of a body of the refuse collection truck.

2. The refuse collection truck, in accordance with claim I, wherein the distal end of the side loader when the collection hopper is in a stowed positon lie within a body outline of a wheel base of the truck.

3. The refuse collection truck, in accordance with claim 1, wherein the distal end of the side loader when the collection hopper is in a stowed positon is behind a line extending from a center of a front wheel to a center of a rear wheel on a side of the refuse collection truck where the side loader is positioned.

4. The refuse collection truck, in accordance with claim I, wherein the side loader comprises:
a boom arm that extends from and retracts into the body of the refuse collection truck;
a pivoting telescoping arm with an upper housing and a lower arm that telescopes out from the upper housing, where a pivoting linkage connects to the upper housing to the boom arm; and
a grabber formed with a pivoting right arm and a pivoting left arm joined to an extension arm, the extension arm fixedly attached to the lower arm; and
wherein when the side loader is stowed, the right arm and left aim of the grabber are recessed in the body of the truck in a half cupped position while remaining inside a wheel base profile of the refuse collection truck.

5. The refuse collection truck, in accordance with claim 4, wherein distal ends of the right arm and left arm of the grabber are recessed in the body of the truck in a half cupped position and positon behind a line extending from a center of a front wheel to a center of a rear wheel on a side of the refuse collection truck where the side loader is positioned.

6. The refuse collection truck, in accordance with claim 4, wherein the side loader comprises a set of actuators for controlling movement of the boom arm and lower arm, pivoting of the telescoping arm, and the pivoting of the right arm and the left arm of the grabber.

7. The refuse collection truck, in accordance with claim 6, wherein the set of actuators are at least one of pneumonic, hydraulic, or electrical.

8. The refuse collection truck, in accordance with claim 4, wherein the extension arm serves to offset the grabber so as to align a collection container to be emptied with a collection hopper of the truck.

9. The refuse collection truck, in accordance with claim 4, wherein the side loader comprises a set of sensors that automatically stop the extension of the boom when contact between a backstop of the grabber and the container is realized.

10. A refuse collection truck, comprising:
a collection bin storing refuse placed in the refuse collection truck;
a tailgate coupled to the collection bin;
a collection hopper coupled to the collection bin, wherein the collection hopper is recessed within a body of the refuse collection truck; and
a side loader coupled to the collection hopper, wherein the side loader comprises:
a boom arm that extends from and retracts into the body of the refuse collection truck;
a pivoting telescoping arm with an upper housing and a lower arm that telescopes out from the upper housing, where a pivoting linkage connects to the upper housing to the boom arm; and
a grabber formed with a pivoting right arm and a pivoting left aim joined to an extension arm, the extension arm fixedly attached to the lower arm;
wherein when the side loader is stowed, the right arm and left arm of the grabber are recessed in the body of the truck in a half cupped position while remaining inside a wheel base profile of the refuse collection truck.

11. The refuse collection truck, in accordance with claim 10, wherein distal ends of the right arm and left arm of the grabber are recessed in the body of the truck in a half cupped position and positon behind a line extending from a center of a front wheel to a center of a rear wheel on a side of the refuse collection truck where the side loader is positioned.

12. The refuse collection truck, in accordance with claim 10, wherein the side loader comprises a set of actuators for controlling movement of the boom arm and lower arm, pivoting of the telescoping arm, and the pivoting of the right arm and the left arm of the grabber.

13. The refuse collection truck, in accordance with claim 12, wherein the set of actuators are at least one of pneumonic, hydraulic, or electrical.

14. The refuse collection truck, in accordance with claim 10, wherein the extension arm serves to offset the grabber so as to align a collection container to be emptied with a collection hopper of the truck.

15. The refuse collection truck, in accordance with claim 10, wherein the side loader comprises a set of sensors that automatically stop the extension of the boom when contact between a backstop of the grabber and the container is realized.

16. A refuse collection truck, comprising:
a collection bin storing refuse placed in the refuse collection truck;
a tailgate coupled to the collection bin;
a collection hopper coupled to the collection bin, wherein the collection hopper is recessed within a body of the refuse collection truck; and
a side loader coupled to the collection hopper, wherein the side loader comprises:
a boom arm that extends from and retracts into the body of the refuse collection truck;
a pivoting telescoping arm with an upper housing and a lower arm that telescopes out from the upper housing, where a pivoting linkage connects to the upper housing to the boom arm;
a grabber formed with a pivoting right arm and a pivoting left arm joined to an extension arm, the extension aim fixedly attached to the lower arm; and
a set of actuators for controlling movement of the boom arm and lower arm, pivoting of the telescoping aim, and the pivoting of the right arm and the left arm of the grabber;
wherein when the side loader is stowed, distal ends of the right arm and left arm of the grabber are recessed in the body of the truck in a half cupped position and positon behind a line extending from a center of a front wheel to a center of a rear wheel on a side of the refuse collection truck where the side loader is positioned.

17. The refuse collection truck, in accordance with claim 16, wherein the set of actuators are at least one of pneumonic, hydraulic, or electrical.

18. The refuse collection truck, in accordance with claim 16, wherein the extension arm serves to offset the grabber so as to align a collection container to be emptied with a collection hopper of the truck.

19. The refuse collection truck, in accordance with claim 16, wherein the side loader comprises a set of sensors that automatically stop the extension of the boom when contact between a backstop of the grabber and the container is realized.
